(19) United States
(12) Patent Application Publication
(10) Pub. No.: US 2012/0091224 A1
(43) Pub. Date: Apr. 19, 2012

(54) Microdroplet Generation Apparatus

(75) Inventors: Shan-Yi Yu, New Taipei City (TW); Han-Chang Liu, New Taipei City (TW); Wen-Yu Tsai, New Taipei City (TW)

(73) Assignee: HEALTH & LIFE CO., LTD., New Taipei City (TW)

(21) Appl. No.: 13/335,422

(22) Filed: Dec. 22, 2011

Related U.S. Application Data
(63) Continuation-in-part of application No. 12/482,647, filed on Jun. 11, 2009.

(30) Foreign Application Priority Data
Feb. 25, 2009 (TW) 098202839

(51) Int. Cl. B05B 1/08

(52) U.S. Cl. 239/102.2

(57) ABSTRACT

A microdroplet generation apparatus comprises an oscillation plate having a first through-hole, a connection plate having a second through-hole corresponding to the first through-hole, a nozzle disc fixed to the connection plate and having a plurality of tiny injection holes on a region thereof corresponding to the first and second through-holes, and a bonding material joining together the oscillation plate and the connection plate. The connection plate has at least one side wall corresponding to and joined with a side wall of the contour or the first through-hole of the oscillation plate. The side walls of the connection plate increase the joined area of the connection plate, whereby is enhanced the joining strength of the connection plate and the oscillation plate, and whereby the connection plate can effectively conduct the vibration energy of the radial and longitudinal Rayleigh waves to the nozzle disc, and whereby is improved liquid atomization.

### CROSS-REFERENCE TO RELATED APPLICATIONS

This application is a Continuation-in-Part of the earlier U.S. Utility Patent Application to Yu, et al. entitled “Microdroplet Generation Apparatus” Ser. No. 12/482,647 filed Jun. 11, 2009, and Taiwan Patent Application to Yu, et al. No. 098202839 file Feb. 25, 2009 the disclosures of which are hereby incorporated entirely herein by reference.

### BACKGROUND OF THE INVENTION

1. Field of the Invention

The present invention relates to a microdroplet generation apparatus applying to a sprayer, particularly to a microdroplet generation apparatus, which can effectively transmit the vibration energy of the radial and longitudinal Rayleigh waves to achieve higher atomization efficiency.

2. Description of the Related Art

In the conventional sprayers and related prior arts, there are basically two means to generate atomized droplets. One is using the vibration of a piezoelectric material to squeeze a liquid out of a nozzle disc to generate microdroplets. Another means is using a piezoelectric material to vibrate a nozzle disc, and using the vibration of the nozzle disc to atomize liquid into microdroplets. In some cases, the latter means adopts a liquid-vibration plane. For example, a bundle of capillary tubes is used to transport a liquid, and the terminals of the capillary tubes are fabricated into a plane. The liquid flowing to the plane is vibrated and atomized into microdroplets. Alternatively, a compressor is used to transport a liquid to a nozzle disc, and the vibrating nozzle disc atomizes the liquid into microdroplets. In the latter means, whether the vibration energy is effectively transmitted to the nozzle disc depends on whether the piezoelectric material and the nozzle disc are joined well.

In the conventional sprayers using an oscillation plate to generate vibration and transmit vibration energy to the nozzle disc, a connection plate or fixing plate is usually interposed between the nozzle disc and the oscillation plate and joined to them with an adhesive material because the nozzle disc is small and thin. Then, at least two materials exist between the nozzle disc and the oscillation plate. Thus, there is a problem of vibration transmission efficiency in addition to the problem of joining multiple materials. When the oscillation plate transmits vibration through several different materials to the nozzle disc, there is energy loss in each energy transfer between two different materials. Consequently, the liquid atomization effect is reduced.

### SUMMARY OF THE INVENTION

The primary objective of the present invention is to provide a microdroplet generation apparatus, which applies to a sprayer, wherein the joined area of the connection plate is increased to enhance the joining strength of the connection plate and the oscillation plate, whereby the vibration energy of the radial and longitudinal Rayleigh waves generated by the oscillation plate can be effectively transmit to the nozzle disc, and whereby liquid atomization is improved.

To achieve the abovementioned objective, the present invention proposes a microdroplet generation apparatus, which comprises an oscillation plate, a connection plate, a nozzle disc and a bonding material, wherein the nozzle disc is fixed to the connection plate, and wherein the oscillation plate and the connection plate are joined by the bonding material. The oscillation plate and the connection plate respectively have a first through-hole and a second through-hole corresponding to each other. The nozzle disc has a plurality of tiny injection holes on the region corresponding to the first through-hole and the second through-hole. The connection plate has at least one side wall corresponding to and joined with the side wall of the first through-hole of the oscillation plate or the side wall of the contour of the oscillation plate.

The present invention is characterized in that the connection plate is designed to have at least one side wall corresponding to and joined with the side wall of the first through-hole of the oscillation plate or the side wall of the contour of the oscillation plate. Thereby the joined area of the connection plate is increased to enhance the joining strength of the connection plate and the oscillation plate. Therefore, the vibration energy of the radial and longitudinal Rayleigh waves generated by the oscillation plate can be effectively transmitted to the nozzle disc via the connection plate.

Below, the embodiments are described in detail in cooperation with the drawings to make easily understood the technical characteristics and efficacies of the present invention.

### BRIEF DESCRIPTION OF THE DRAWINGS

FIG. 1 is an exploded view of a microdroplet generation apparatus according to the present invention;

FIG. 2 is a perspective view of a microdroplet generation apparatus according to a first embodiment of the present invention;

FIG. 3 is a sectional view of the microdroplet generation apparatus according to the first embodiment of the present invention;

FIG. 4 is a sectional view of a microdroplet generation apparatus according to a second embodiment of the present invention;

FIG. 5 is an exploded view of a microdroplet generation apparatus according to a third embodiment of the present invention;

FIG. 6 is a sectional view of the microdroplet generation apparatus according to the third embodiment of the present invention; and

FIG. 7 is a perspective view of a connection plate according to a fourth embodiment of the present invention.

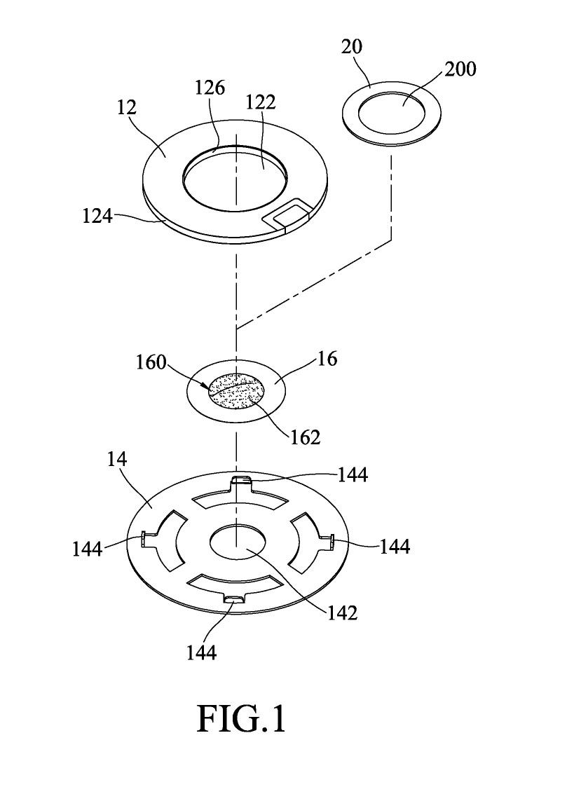

FIG. 1 is assigned to be the representative drawing.

### DETAILED DESCRIPTION OF THE INVENTION

The technical contents of the present invention are described in detail in cooperation with the drawings below.

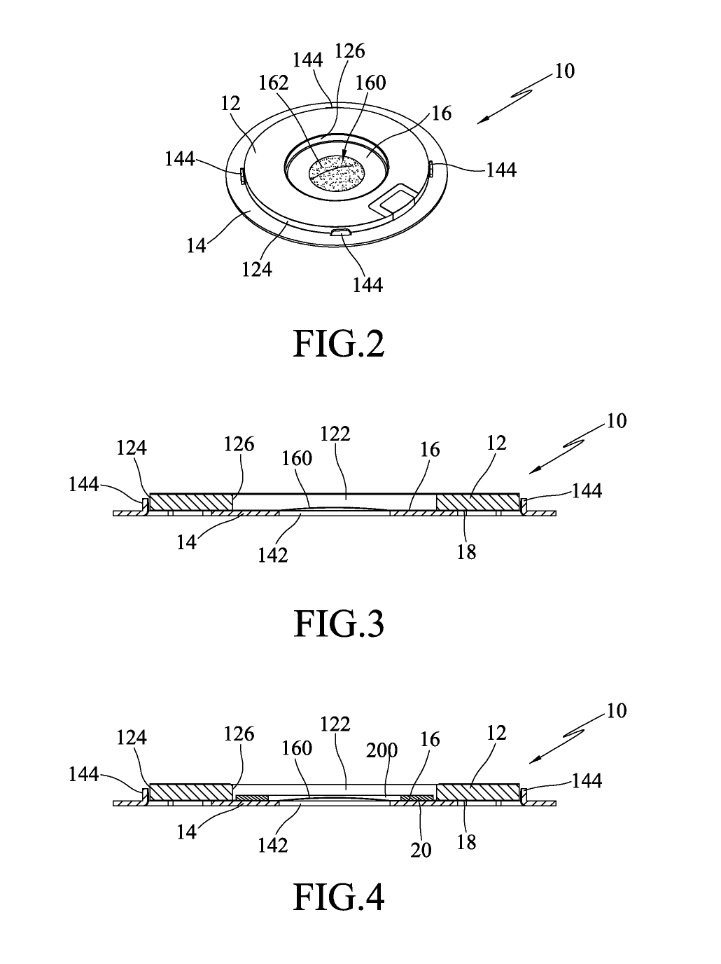

The present invention discloses a microdroplet generation apparatus applying to a sprayer. Refer to FIGS. 1-3. FIG. 1 is an exploded view of a microdroplet generation apparatus according to the present invention. FIG. 2 and FIG. 3 are respectively a perspective view and a sectional view of a microdroplet generation apparatus according to a first embodiment of the present invention. The microdroplet generation apparatus 10 of the first embodiment contains a plurality of plate-like structures stacked together. In the first embodiment, the microdroplet generation apparatus 10 comprises an oscillation plate 12, a connection plate 14, a nozzle disc 16, and a bonding material 18, wherein the nozzle disc 16 is fixed to the connection plate 14, and wherein the oscillation plate 12 and the connection plate 14 are joined by the bonding material 18. The oscillation plate 12 is a circular plate-like structure, preferably a piezoelectric plate. The oscillation plate 12 has a first through-hole 122 at the center thereof. The connection plate 14 is a circular stainless plate-like structure and has a second through-hole 142 at the center thereof and corresponding to the first through-hole 122. When the oscillation plate 12 and the connection plate 14 are stacked together, the first through-hole 122 and the second through-hole 142 interconnect. The connection plate 14 has one or more side walls 144 corresponding to the side wall 124 of the contour of the oscillation plate 12 and joined to the side wall 124 of the contour of the oscillation plate 12 by the bonding material 18. In the present invention, the boding material 18 may be but is not limited to be a curable glue (such as an epoxy adhesive) or a metallic soldering material.

The nozzle disc 16 is a circular plate-like structure fixed to the connection plate 14. The nozzle disc 16 has a plurality of tiny injection holes 162 at the central region corresponding to the first through-hole 122 and the second through-hole 142. On the nozzle disc 16, the region corresponding to the first through-hole 122 and the second through-hole 142 is fabricated into a convex surface 160, and the tiny injection holes 162 are formed on the convex surface 160.

In the first embodiment, the microdroplet generation apparatus 10 is constructed via joining together the oscillation plate 12, the connection plate 14 and the nozzle disc 16 with the bonding material 18, wherein the nozzle disc 16 is fixed to the connection plate 14. The more than one side wall 144 of the connection plate 14 is corresponding to the side wall 124 of the contour of the oscillation plate 12 and joined to the side wall 124 of the contour of the oscillation plate 12 by the bonding material 18, whereby the joined area of the connection plate 14 is increased to enhance the joining strength of the connection plate 14 and the oscillation plate 12, and whereby the connection plate 14 can effectively transmit the vibration energy of the radial and longitudinal Rayleigh waves generated by the oscillation plate 12 to the nozzle disc 16.

Refer to FIG. 1 and FIG. 4. FIG. 4 shows a sectional view of a microdroplet generation apparatus according to a second embodiment of the present invention. In the second embodiment, the microdroplet generation apparatus 10 further comprises a fixing plate 20, in addition to the oscillation plate 12, connection plate 14 and nozzle disc 16, which are joined together by the bonding material 18. The fixing plate 20 is a circular plate-like structure arranged between the oscillation plate 12 and the connection plate 14. The nozzle disc 16 is clamped by the fixing plate 20 and the connection plate 14. The fixing plate 20 has a third through-hole 200 at the center thereof and corresponding to the first through-hole 122 and the second through-hole 142.

Therefore, the microdroplet generation apparatus 10 of the present invention may be alternatively constructed via joining together the oscillation plate 12, connection plate 14, nozzle disc 16 and fixing plate 20 with the bonding material 18, wherein the nozzle disc 16 is clamped by the fixing plate 20 and the connection plate 14.

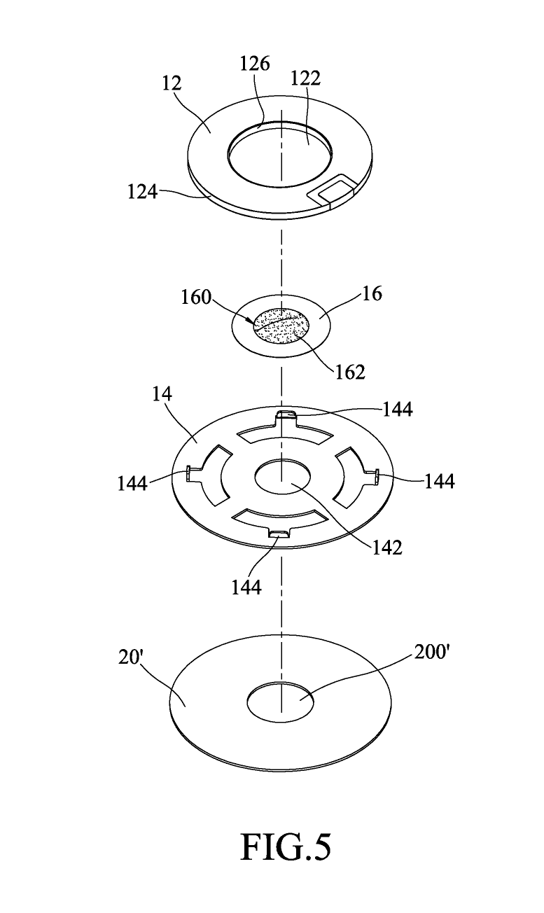

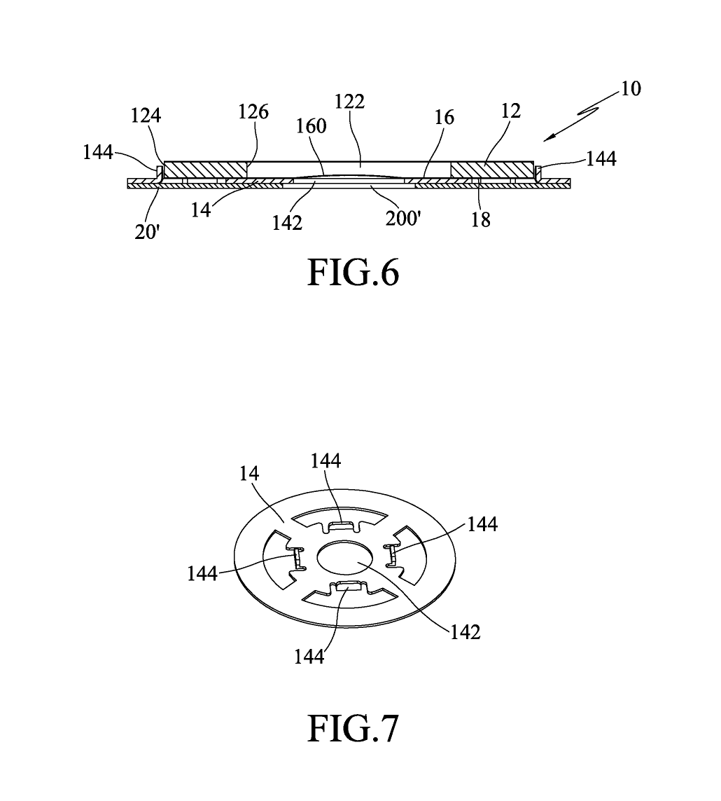

Refer to FIG. 5 and FIG. 6. FIG. 5 and FIG. 6 respectively show an exploded view and a sectional view of a microdroplet generation apparatus according to a third embodiment of the present invention. In the third embodiment, the microdroplet generation apparatus 10 also contains several plate-like structures. However, the microdroplet generation apparatus 10 of the third embodiment is slightly different from that of the second embodiment in the relative positions of the plate-like structures. In the third embodiment, the microdroplet generation apparatus 10 comprises an oscillation plate 12, a connection plate 14, a nozzle disc 16, and a fixing plate 20′, which are joined together by a bonding material 18. The third embodiment is different from the second embodiment in that the fixing plate 20′ is a circular plate-like structure arranged below the connection plate 14 and that the fixing plate 20′ has a third through-hole 200′ at the center thereof and corresponding to the first through-hole 122 and the second through-hole 142.

The present invention is characterized in that the connection plate 14 is designed to have more than one side wall 144 corresponding to the side wall 124 of the contour of the oscillation plate 12. Thereby, the joined area of the connection plate 14 is increased to enhance the joining strength of the connection plate 14 and the oscillation plate 12. Thus, the connection plate 14 can effectively transmit the vibration energy of the radial and longitudinal Rayleigh waves generated by the oscillation plate 12 to the nozzle disc 16.

Refer to FIG. 1 and FIG. 7. FIG. 7 shows a perspective view of a connection plate according to a fourth embodiment of the present invention. In the fourth embodiment, the side walls 144 of the connection plate 14 are arranged corresponding to the side wall 126 of the first through-hole 122 of the oscillation plate 12. In another embodiment, the connection plate 14 has an annular side wall corresponding to the side wall 124 of the contour of the oscillation plate 12 or the side wall 126 of the first through-hole 122 of the oscillation plate 12.

In conclusion, the present invention proposes a microdroplet generation apparatus 10 applying to a sprayer. The present invention increases the joined area of the connection plate 14 to enhance the joining strength of the connection plate 14 and the oscillation plate 12, whereby the connection plate 14 can effectively transmit the vibration energy of the radial and longitudinal Rayleigh waves generated by the oscillation plate 12 to the nozzle disc 16, and whereby liquid atomization is improved. The improvement of liquid atomization is attributed to the design of side walls 144 of the connection plate 14. The side walls 144 are arranged corresponding to the side wall 124 of the contour of the oscillation plate 12 or the side wall 126 of the first through-hole 122 of the oscillation plate 12. The side walls 144 increase the joined area of the connection plate 14 and thus enhance the joining strength of the connection plate 14 and the oscillation plate 12. Therefore, the connection plate 14 can effectively transmit the vibration energy of the radial and longitudinal Rayleigh waves generated by the oscillation plate 12 to the nozzle disc 16.

The embodiments described above are only to exemplify the present invention but not to limit the scope of the present invention. Any equivalent modification or variation according to the spirit of the present invention is to be also included within the scope of the present invention.

What is claimed is:

1. A microdroplet generation apparatus, which applies to a sprayer, comprising
an oscillation plate having a first through-hole and generating radial and longitudinal Rayleigh waves;
a connection plate having a second through-hole corresponding to said first through-hole and at least one side wall corresponding to and joined with a side wall of said oscillation plate;
a nozzle disc fixed to said connection plate and having a plurality of tiny injection holes on a region thereof, which is corresponding to said first through-hole and said second through-hole; and
a bonding material used to join said oscillation plate and said connection plate.

2. The microdroplet generation apparatus according to claim 1, wherein said oscillation plate is a piezoelectric plate.

3. The microdroplet generation apparatus according to claim 1, wherein said nozzle disc has a convex surface corresponding to said first through-hole and said second through-hole, and wherein said tiny injection holes are formed on said convex surface.

4. The microdroplet generation apparatus according to claim 1, wherein said connection plate is a stainless steel plate.

5. The microdroplet generation apparatus according to claim 1, wherein said side wall of said oscillation plate is a side wall of said first through-hole.

6. The microdroplet generation apparatus according to claim 5, wherein said connection plate has a plurality of side walls.

7. The microdroplet generation apparatus according to claim 5, wherein said connection plate has an annular side wall.

8. The microdroplet generation apparatus according to claim 1, wherein said side wall of said oscillation plate is a side wall of a contour of said oscillation plate.

9. The microdroplet generation apparatus according to claim 8, wherein said connection plate has a plurality of side walls.

10. The microdroplet generation apparatus according to claim 8, wherein said connection plate has an annular side wall.

11. The microdroplet generation apparatus according to claim 1, wherein said bonding material is a curable glue.

12. The microdroplet generation apparatus according to claim 1, wherein said bonding material is a metallic soldering material.

13. The microdroplet generation apparatus according to claim 1, wherein said bonding material is an epoxy adhesive.

14. The microdroplet generation apparatus according to claim 1 further comprising a fixing plate, wherein said fixing plate has a third through-hole corresponding to said first through-hole and said second through-hole.

15. The microdroplet generation apparatus according to claim 14, wherein said fixing plate is arranged between said oscillation plate and said connection plate, and wherein said nozzle disc is clamped by said fixing plate and said connection plate.

16. The microdroplet generation apparatus according to claim 14, wherein said fixing plate is joined to a bottom of said connection plate.
